(19) United States
(12) Patent Application Publication
(10) Pub. No.: US 2010/0024277 A1
(43) Pub. Date: Feb. 4, 2010

(54) Lateral quick connect-disconnect fish hook coupling system

(76) Inventor: Larry Ross, Huntsville (CA)

Correspondence Address: Nields, Lemack & Frame, LLC, 176 E. Main Street, Suite #5, Westborough, MA, 01581, US

(21) Appl. No.: 12/221,380

(22) Filed: Aug. 1, 2008

(51) Int. Cl. A01K 83/00; A01K 85/00

(52) U.S. Cl. 43/44.83; 43/43.16; 43/42.09

(57) ABSTRACT

A holder for a fish hook is provided. The holder has a generally O- or U-shaped wire body having a first end and a second end. The first end is slightly spaced away from the second end for attachment to a lure body. The second end has a branched terminus with opposing first and second branches. The holder has an undercut that extends into the wire body without severing it. The second end is adapted to receive an eye of the fish hook by placing the eye over the first and second branches in sequence using the undercut in one position to thread the fish hook onto the wire body. Various designs of holders are possible with the common theme being that the branched terminus of the second end is sized to prevent an eye of a fish hook from passing over both the first and second branch simultaneously. The holders may also be part of a fishing lure.

### FIELD OF THE INVENTION

The invention relates to hooks and lures for fishing, and more particularly, relates to methods of coupling fish hooks and lures.

### BACKGROUND OF THE INVENTION

Fishing continues to be a very popular sport. Fishermen enjoy the challenge of outwitting fish—and lure technology has become very sophisticated.

However, there is an area of fishing technology that has not benefited from the rising sophistication. Fishing lures are not very modular—and do not allow easy adaptation from one hook to another.

Fishing lures are typically purchased, utilized and stored by fishermen with a hook or hooks attached. However, for various reasons, a fisherman might want to change hooks on a lure. Hooks may dull or break in use and require sharpening or replacement. Lures are often supplied with inferior quality hooks. The hook points on these hooks are often dull and will not “hold” a sharpening as long as higher quality hooks will. As a result, a fisherman may want to remove hooks supplied with a lure to replace them with higher quality (and more expensive) hooks that are purchased individually.

A fisherman may desire to switch a hook for one of higher quality or one having a different configuration. For example, he may want to swap the hook for a red hook. A recent popular trend is the use of hooks that are painted red. Many lures are now shipped and sold with red hooks attached. The theory is that the red hooks themselves attract fish (perhaps because they look like blood in the water) and encourage the fish to bite the lure. In addition, the red hooks tend to be higher quality and have very sharp points as compared to most available hooks.

There is also a trend to the use of barbless hooks (mandatory in some fishing areas). Conservation and “catch and release” fishing is becoming very popular in the fishing community. The barb on the hook helps to ensure that fish have a more difficult time disengaging themselves from the hook but it also makes it much more difficult to release the fish once landed. Disengaging a barbed hook from a fish often results in tearing of the fish's mouth which may result in a higher mortality rate among released fish. The use of barbless hooks allows the fisherman to easily remove the hook and release the fish without harming it. In many jurisdictions, barbless (and often single barbless) hooks are mandatory.

With existing mechanisms, removing or switching hooks for any of these reasons is not an easy matter.

The hooks are typically attached to the lure through the use of a “split ring” connector. A split ring is similar to a key ring, only considerably smaller (usually on the order of about 2-5 mm in diameter). By manually “splitting” the overlapping sides of the split ring (for example, with one's fingernail or finger tip), the top end of the hook (which has a loop or an eye) can be slid onto an outer end of the split ring. The hook is then slid inwardly along the ring until it passes over the inner end of the ring. At that point, the hook is attached to the split ring. To remove the hook, the process is reversed. The split ring remains attached to the lure. Changing hooks with this type of connector is very difficult and time consuming and, as a result, most fishermen are reluctant to change hooks, especially in the field. The split rings are typically very small, requiring a high level of finger strength and dexterity. This may be particularly challenging with cold or wet hands, and impossible while wearing gloves.

Split rings also make it difficult to remove a hook to store it separately from the lure body. For practical purposes, the only time that hooks need be attached to the lure is when the lure is actually being used for fishing. At other times having the hooks attached to the lure is actually a detriment. In close proximity to each other when stored in a tackle box, the attached hooks on the lures become tangled making it difficult for the fisherman to select and extract one particular lure from the tackle box for use. The attached hook points will also quickly become dull as they collide with adjacent lures and other hooks.

Having the hooks attached to the lures in storage can also pose a physical danger. In selecting and handling lures, the fisherman can get cut or pricked by the hooks (in some cases causing embedment of the hook). This is a particular concern for children, who may not be as careful or attentive in handling the lures as adults.

It would be desirable to provide a fish hook coupling system that allows for quick connection and disconnection of the fish hook to avoid the aforementioned difficulties.

### SUMMARY OF THE INVENTION

According to a first aspect of the invention, a holder for a fish hook is provided. The holder has a generally O- or U-shaped wire body having a first end and a second end. The first end ;s slightly spaced away from the second end and slightly flattened for attachment to a lure body. The second end has a branched terminus with opposing first and second branches. At least one of the branches has an undercut that extends into the wire body without severing it. The second end is adapted to receive an eye of the fish hook by placing the eye over the first and second branches in sequence using the undercut at one position to thread the fish hook onto the wire body. The branched terminus is sized such that the eye of the fish hook cannot pass over the first and second branches simultaneously.

Preferably, the second end has a widened portion. Preferably, the widened portion is spaced away from the branched terminus. Preferably, the widened portion is spaced away from the undercut. In one possible embodiment, the widened portion is an integral bulge in the wire body. In another possible embodiment, the widened portion is a ring or tube segment on the wire body. Other embodiments are possible.

Preferably, the dimensions of the holder are selected to closely match the dimensions of the eye of the fish hook, so that the hook can only be threaded onto the holder in one possible orientation. However, the dimensions should not be so closely matched that it becomes too difficult for a user to connect and disconnect the hook. The holder and hook should be able to be mutually connected and disconnected readily without tools. However, they should not come apart inadvertently.

Preferably, the distance from an innermost point of the undercut to an outermost point of the opposing branch is less than or equal to the longest diameter inside the eye of the fish hook. Preferably, the longest diameter inside the eye of the fish hook is less than the longest distance across the branched terminus.

Preferably, the wire body comprises a filament having a generally round cross-section. Portions of the wire body may not be round. For instance, the first end and the branched terminus of the second end may be generally flattened. In the case of the first end, this is to allow the end to be embedded (or otherwise attached—e.g. threaded) in the lure body. In the case of the branched terminus, a flattened end may promote easier connection and disconnection of the hook.

Preferably, the first end and the branched terminus are flattened in parallel planes to each other.

Various shapes of the branched terminus are possible. For instance, the branched terminus may form a Y- or a V- or a <- or a >-shape. Alternatively, the branched terminus may form an Δshape.

According to a second aspect of the invention, a fishing lure is provided having a holder for receiving a fish hook. The lure has a lure body, and at least one generally O- or U-shaped wire body attached to the lure body having a free end slightly spaced away from the lure body. The free end has a branched terminus with opposing first and second branches. The free end has an undercut that extends into the wire body without severing it. The wire body is adapted to receive an eye of the fish hook by placing the eye over the first and second branches in sequence using the undercut at one position to couple the fish hook to the lure body. The branched terminus is sized such that the eye of the fish hook cannot pass over the first and second branches simultaneously.

As previously described, various configurations of the branched terminus are possible. For instance, at least one of the branches may point toward the lure body. Alternatively, at least one of the branches may point in a direction perpendicular to the lure body.

### BRIEF DESCRIPTION OF THE DRAWINGS

FIG. 1 is a perspective view of an embodiment of the present invention used on a body bait lure.

FIG. 2A is a perspective view of a treble hook for use with the present invention.

FIG. 2B is a perspective view of a single hook for use with the present invention.

FIG. 3A is a side view of the hook holder according to the embodiment shown in FIG. 1 (first embodiment).

FIG. 3B is an end view of the holder in FIG. 3A (first embodiment).

FIG. 4A is an end view of the holder showing a first stage of attaching a fish hook (first embodiment).

FIG. 4B is an end view of the holder showing a second stage of attaching a fish hook (first embodiment).

FIG. 5A is an end view of the holder showing a third stage of attaching a fish hook (first embodiment).

FIG. 5B is an end view of the holder showing a fourth and final stage of attaching a fish hook (first embodiment).

FIG. 6 is an end view of a holder according to a second embodiment.

FIG. 7A is an end view of the holder in FIG. 6 showing a first stage of attaching a fish hook (second embodiment).

FIG. 7B is an end view of the holder in FIG. 6 showing a second stage of attaching a fish hook (second embodiment).

FIG. 8A is an end view of the holder in FIG. 6 showing a third stage of attaching a fish hook (second embodiment).

FIG. 8B is an end view of the holder in FIG. 6 showing a fourth and final stage of attaching a fish hook (second embodiment).

### DETAILED DESCRIPTION OF THE DRAWINGS

The invention provides a system 10 allowing for the quick connection and disconnection of fishing hooks.

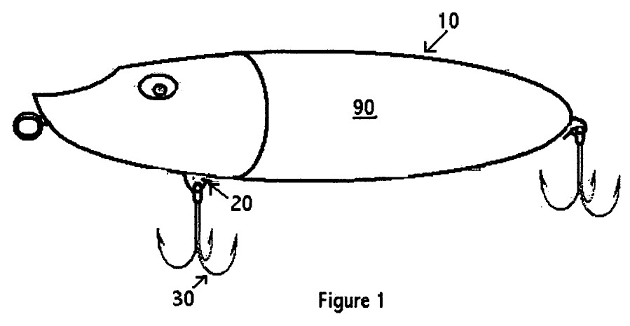

As shown in FIG. 1, fish hooks 30 can be connected to a lure body 90 with lateral quick-connect-disconnect holders 20. Any number of holders can be used on a lure body, at any position on the body. Also, the holders may each hold more than one hook (dependent on the size of the holder), although some tangling may result.

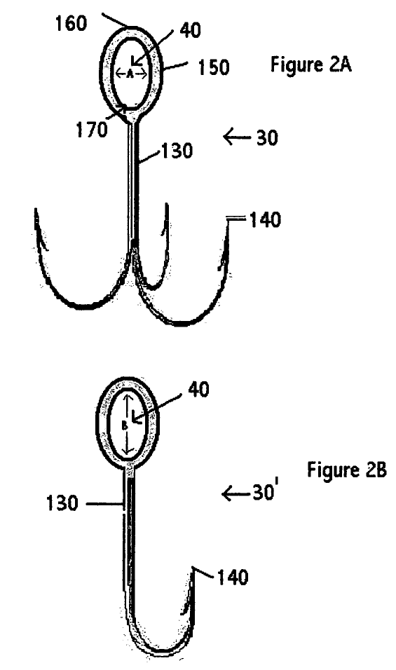

As shown in FIGS. 2A and 2B, hooks of different configurations may be used. For instance, treble 30 or single 30′ hooks can be used. Opposite its pointed end(s) 140, but also connected to the central shaft 130, the hook has an eye (loop 150 that defines a round, or more preferably oval-shaped, opening 40). Other baits or attractants (not shown) may be additionally coupled to the hook (such as live or artificial worms, minnows, etc.).

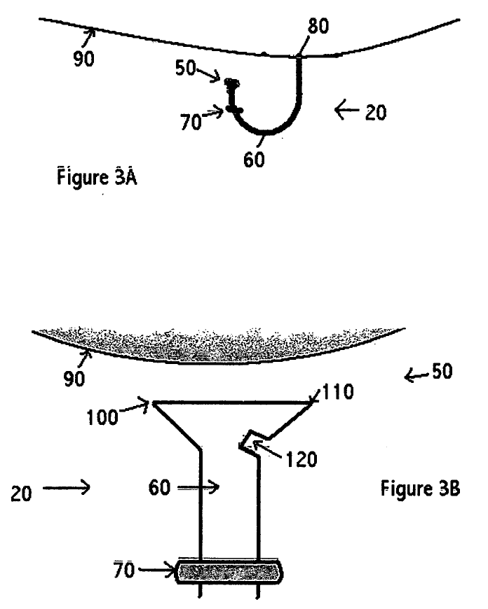

The hook holder is shown in detail in FIG. 3A. As shown in the Figure (side view), the holder 20 has an attachment end (first end) 80 and a free end (second end) 50. The attachment end 80 is attached to, molded with or embedded in the lure body 90. The precise method of attachment is not critical, but the holder should be retained stably and securely on the body, and is preferably not movable relative to the holder (as this will make attachment of the fish hook more difficult).

A first embodiment of the holder is shown in FIG. 3B (end view of the free end of the holder). The free end of this embodiment of the holder has an upwardly facing branched terminus (generally, 50). First 100 and second 110 branches preferably diverge from a central shaft 60. The branches may simply be points on an inverted triangle (as shown in the Figure), or they may diverge in a V formation. Preferably, the shaft 60 has an undercut 120, generally located below (or on) one of the branches (in this case, 110). The shaft also preferably has a widened portion 70. This may be a ring element that encircles the shaft, or it may simply be a wider portion of the shaft.

The holder may be constructed of any suitable material or materials. Rust-proof metal (or coated metal), plastic, or nylon are some possible choices. The materials should be able to withstand wide temperature variation, freezing and thawing, extended immersion in water, and exposure to the elements (e.g. UV stable plastics and paint coatings may be preferred).

Molding or stamping/forming processes may be used to manufacture the holder (which processes are well-known in the art). It is believed that the holder could be manufactured as a unitary piece.

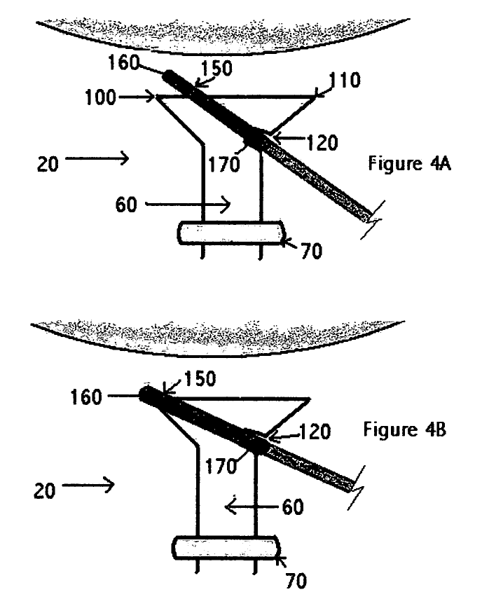

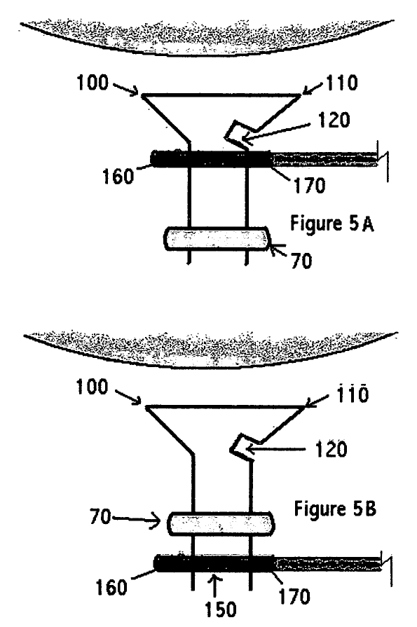

The connection of a hook 30 to the first embodiment holder 20 is best seen in FIGS. 4A-5B. The hook is shown in side view in these Figures. Greater detail of two possible hook embodiments (treble hook 30 and single hook 30′) can be seen in FIGS. 2A and 2B (viewed from the front). By placing the eye (loop 150) of the hook 30 over one branch of the free end at a time, the hook 30 can be threaded onto the shaft 60 of the holder 20.

Let's examine in more detail how this is done using the first embodiment. The first stage of the process is shown in FIG. 4A. The eye is passed over branch 110 (i.e. the branch closest to the undercut 120). As seen in the Figure, the bottommost edge of the loop 170 engages the undercut 120. This allows the topmost edge of the loop 160 to be extended toward the other (distal) branch 100. The hook must be held (by the user) at an angle to make this work.

The second stage of the process is shown in FIG. 4B. The eye (while still threaded over branch 110, and still engaging the undercut 170) is next threaded onto the other branch 100. This is done by the user tilting the eye end of the hook downward (i.e. tilting the shaft of the hook upward), so that the topmost edge 160 passes over the branch 100.

Now that the hook eye has cleared the widest part of the holder, slightly greater mobility of the hook is Possible. However, the hook should be kept more or less horizontal (i.e. perpendicular to the shaft of the holder) to allow it to clear one last obstacle. The third and fourth stages of the process are shown in FIGS. 5A and 5B. The eye of the hook (now disengaged from the branches 100, 110 of the free end, and disengaged from the undercut 120) is brought down the shaft of the holder. As shown in FIG. 5B, the loop must be passed over the widened portion 70. The hook, thus connected, can now be allowed to drop down to rest loosely in the bottom (rounded) portion of the holder (best seen in FIG. 1). As shown in FIG. 1, the free end of the holder may be toward the front of the lure or the back.

In the water, or while casting, the hook can move freely on the holder, but it will not disengage, due to the obstacles of the widened portion and the branched terminus. To be disconnected, the hook simply follows the same process in reverse. The user pulls the hook to horizontal, passes it over the widened portion, and then, successively over the first and second branches at an angle. The hook, once disengaged, can be removed through the gap between the body and the free end of the holder.

This system works in part due to the fact that, as shown in FIGS. 2A and 2B, dimension “A” on the interior of the loop 40 (i.e. the horizontal span across the eye of the hook) is smaller than dimension “B” (i.e. the vertical span across the eye of the hook). The dimension “A” is only barely long enough to extend the distance from the inside of the undercut 120 to the outside point of the distal branch (in this case, 100). If the hook were oriented differently, the dimension “B” would not allow it to clear the distal branch 100. Thus, engaging and disengaging the hook is only possible in one orientation at the critical point of clearing the distal branch (i.e. the second stage described above).

The widened portion 70 also serves an important function. When a lure is cast out, the hook is sent towards the free end 50 of the hook holder 20 as the lure is flying through the air in a backwards position. This is opposite to the force on the hook when retrieving or trolling a lure or when fighting a fish. The widened portion 70 stops the hook from moving towards the free end 50 of the hook holder 20 as the widest point of the portion is slightly smaller than dimension “B” in FIG. 2B, yet larger than dimension “A”. The hook can easily be removed across the widening by the user as the user can hold on to the lure and turn the hook to be perpendicular to the holder shaft (i.e. horizontal, as illustrated).

When a fish bites and is attached to the hook, it is unable to disengage the hook from the holder because the pressure that the fish exerts is toward the rear of the lure, away from the location where the fishing line is connected to the lure. In order to disengage the hook from the holder, the hook must be moved toward the front of the lure and turned. This is not possible for the fish to accomplish, as the fish does not have hands. As the fish twists and turns it cannot exert the required forward or upward pressure on the hook as it is akin to pushing on a rope. Unless the body of the lure can be held securely, and forward and upward pressure exerted on the hook at the same time, the hook cannot be disengaged from the receiver. Only the user can perform this task. Even if the fish were able to exert enough forward pressure on the hook to move it towards the top and front of the holder, the fact that dimension “A” (in FIG. 2A) is smaller than dimension “B” (in FIG. 2B) ensures that the hook may not be removed from the holder in this position. The only way to remove the hook is to tilt it up and insert the loop of the hook into the undercut 70.

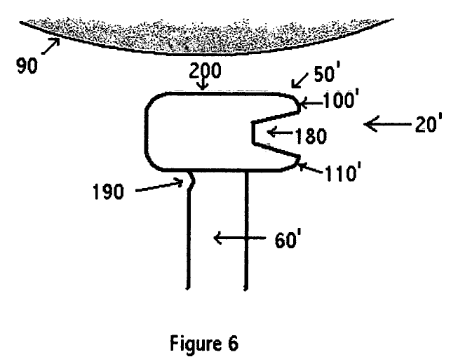

An alternative hook holder head design is shown in FIG. 6 (second embodiment). It is similar to the first embodiment shown in FIG. 3B, however the branched terminus 50′ is directed sideways (perpendicular to the shaft of the holder 60′ and perpendicular to the lure body 90).

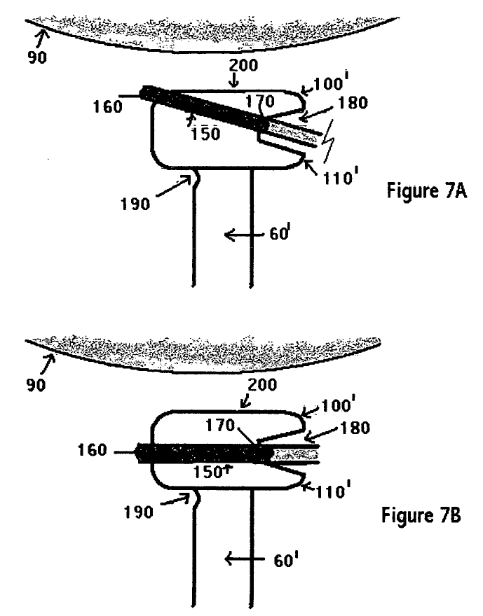

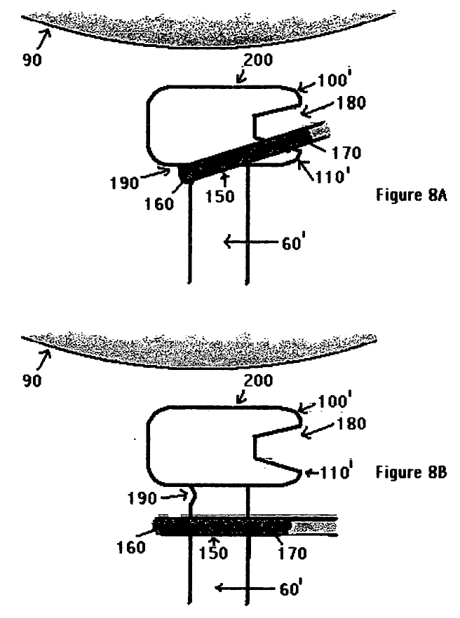

The process to attach a fish hook to the second embodiment hook holder is shown in FIGS. 7A-8B. The first stage of the process is shown in FIG. 7A. The eye of the hook 150 is passed over branch 100′ (topmost branch). It is then allowed to clear the opposite top corner of the head 200. The bottommost edge of the hook eye 170 engages the slot 180 between the branches 100′ and 110′ in order to clear the opposite side with the topmost edge of the eye 160. The hook is held by the user at an angle (eye angled upward).

The second stage of the second embodiment process is shown in FIG. 7B. The eye 150 (still engaging slot 180) is brought down further over head 200.

The last obstacle is to clear the second branch 110′ (bottommost branch). To do this, as shown in the third stage diagram in FIG. 8A, the topmost edge of the hook eye 160 is brought close to engage undercut 190 just below the head 200 (eye angled downward). This allows the bottommost edge of the eye 170 to swing out of slot 180 and downward toward branch 110′.

The fourth stage is shown in FIG. 8B. The eye is brought down over branch 110′. Now, it is fully past the head 200 and is fully threaded onto shaft 60′ of the holder. It can be dropped into place now and will swing freely without being inadvertently disengaged from the holder.

Although it sounds complicated, the connection and disconnection (using either embodiment described) can actually be accomplished by a human user in seconds, and is not dependent on strength or fiddly manipulation with a fingernail (or tools). The fisherman can connect and disconnect hooks while wearing gloves. Further, the holders do not become bent or strained from use, and are thus, more durable than a standard split ring.

Thinking more broadly, there are various advantages to allowing hooks and lures to be readily connected and disconnected. They could be stored separately, and purchased separately, opening up an array of possibilities for variation. The fisherman could purchase a kit containing hooks of various sizes and colours. Only a few hooks of each size would be required and each hook would work for all lures of a similar size. The kit could include red hooks as well as hooks with additional attractors. Fishing lures could then be manufactured and shipped without hooks. Fishermen could purchase and store the hookless lures avoiding the problems associated with safety, lures tangling and hooks becoming dull in storage.

In the hook kit, the various hooks would be stored separately from each other to avoid hook collisions that would dull the points. When the hook points become dull through normal use they may be sharpened or the hook may be properly be disposed and a new hook purchased. This system allows the fishermen to purchase and maintain a very small number of hooks yet ensures that a sharp, high quality hook is used every time a lure is fished.

This invention will greatly enhance the enjoyment and safety of the fishing experience. The holder is simple, durable and inexpensive to manufacture. It may easily be inserted into the lure body during the normal manufacturing process. The ability to quickly change hooks will allow for flexibility in the field and increase the confidence and ultimately the success for the fisherman.

While the foregoing is directed to embodiments of the present invention, other and further embodiments of the invention may be devised without departing from the basic scope thereof, and the scope thereof is determined by the claims that follow.

1. A holder for a fish hook, comprising:
a generally O- or U-shaped wire body having a first end and a second end;
the first end being slightly spaced away from the second end for attachment to a lure body; and
the second end having a branched terminus with opposing first and second branches, the second end having an undercut that extends into the wire body without severing it, the branched terminus adapted to receive an eye of the fish hook by placing the eye over the first and second branches in sequence using the undercut at one position to thereby thread the fish hook onto the wire body;
wherein the branched terminus is sized such that the eye of the fish hook cannot pass over the first and second branches simultaneously.

2. The holder of claim 1, wherein the second end has a widened portion.

3. The holder of claim 2, wherein the widened portion is spaced away from the branched terminus.

4. The holder of claim 2, wherein the widened portion is spaced away from the undercut.

5. The holder of claim 2, wherein the widened portion is a bulge in the wire body.

6. The holder of claim 2, wherein the widened portion is a ring or tube segment disposed on the wire body.

7. The holder of claim 1, wherein the distance from an innermost point of the undercut to an outermost point of the opposing branch is less than or equal to the longest diameter inside the eye of the fish hook.

8. The holder of claim 7, wherein the longest diameter inside the eye of the fish hook is less than the longest distance across the branched terminus.

9. The holder of claim 1, wherein the wire body comprises a filament having a generally round cross-section.

10. The holder of claim 9, wherein the first end and the branched terminus of the second end are generally flattened.

11. The holder of claim 10, wherein the first end and the branched terminus are flattened in parallel planes to each other.

12. The holder of claim 1, wherein the branched terminus forms a Y- or a V- or a <- or a >-shape.

13. The holder of claim 1, wherein the branched terminus forms a Δshape.

14. A fishing lure having a holder for receiving a fish hook, comprising:
a lure body;
at least one generally O- or U-shaped wire body attached to the lure body having a free end slightly spaced away from the lure body, the free end having a branched terminus with opposing first and second branches, the free end having an undercut that extends into the wire body without severing it;
wherein the wire body is adapted to receive an eye of the fish hook by placing the eye over the first and second branches in sequence using the undercut at one position to thereby couple the fish hook to the lure body; and
wherein the branched terminus is sized such that the eye of the fish hook cannot pass over the first and second branches simultaneously.

15. The fishing lure of claim 14, wherein at least one of the branches of the branched terminus points toward the lure body.

16. The fishing lure of claim 14, wherein at least one of the branches of the branched terminus points in a direction perpendicular to the lure body.
